(19) United States
(12) Patent Application Publication
(10) Pub. No.: US 2007/0140324 A1
(43) Pub. Date: Jun. 21, 2007

(54) Apparatus for FPGA Programming to synchronize with CDMA signals

(75) Inventor: Tetsuaki Ikoma, Hyogo (JP)

Correspondence Address: Paul D. Greeley;Ohlandt, Greeley, Ruggiero & Perle, L.L.P., One Landmark Square, 10th Floor, Stamford, CT, 06901-2682, US

(73) Assignee: Agilent Technologies, Inc.

(21) Appl. No.: 11/541,883

(22) Filed: Oct. 2, 2006

(30) Foreign Application Priority Data
Dec. 15, 2005 (JP) 2005-361205

(51) Int. Cl. H04B 1/00

(52) U.S. Cl. 375/149

(57) ABSTRACT

Multiple pseudo-noise codes, each of a different phase, are generated in an acquisition device; the multiple pseudo-noise codes are grouped into N number of groups; and time-division multiplexing is performed for each group on each correlation processing of the pseudo-noise codes contained in the signals under test and each pseudo-noise code. Pseudo-noise codes are periodically and repeatedly selected under a fixed order and timing.

### FIELD OF THE INVENTION

The present invention relates to a CDMA device and in particular, to a CDMA device having an acquisition function.

### DISCUSSION OF THE BACKGROUND ART

Direct-spread CDMA receivers, such as W-CDMA portable telephones and base stations, must be synchronized with the spread-spectrum code of the reception signals in order to demodulate the reception signals. Typical synchronization methods are the method that uses a sliding correlator for serial processing and the method that uses a matched filter for parallel processing (refer to JP Unexamined Patent Application (Kokai) 2000-36775 (page 3, FIGS. 21 and 22); JP Unexamined Patent Application (Kokai) 2001-7734 (pages 3 and 5, FIG. 1); JP Unexamined Patent Application (Kokai) 11-112,384 (pages 4 through 8, FIGS. 2 and 6); JP Unexamined Patent Application (Kokai) 10-98,412 (FIG. 1); JP Unexamined Patent Application (Kokai) 8-111,653 (pages 4 and 5, FIGS. 1 through 4); Sugawara, T., Miyanaga, T. “Structure of Parallel Digital Multifilter for DS-CDMA Wherein the Amount of Mathematical Operation is Reduced,” Nov. 5-7, 2003, 18^{th} Digital Signal Processing Symposium; Essam Sourour, Someshwar C. Gupta, “Direct-Sequence Spread-Spectrum Parallel Acquisition in Nonselective and Frequency-Selective Rician Fading Channels”, U.S. Selected Areas in Communications, IEEE Journal, Volume 10, Issue 3, April 1992, pp. 535-544; Makoto Yamada, Yukiyoshi Kamio, Yoshio Wada, “Acquisition of Direct-Sequence Spread-Spectrum Signal with Parallel Matched Filters,” Sep. 18-21, 2000, Personal, Indoor, and Mobile Radio Communications, 2000, PIMRC 2000, The 11^{th} IEEE International Symposium; TAN, Xiao-Heng, YANG, Shi-zhong, “The Design and FPGA Realization of the Long PN Code Acquisition Circuit Based on Digital matched-Filter”, October 2003, ASIC, 2003. Proceedings. 5^{th} International Conference; and June Moon, Yang Hwan Lee, “Parallel Acquisition of PN Sequences in Rayleigh Fading Channel and the Application to the Multi-Carrier CDMA Systems,” September 30 to October 3, 2001, Personal, Indoor, and Mobile Radio Communications, 2001, 12^{th} IEEE International Symposium). Acquisition that is synchronization by these methods uses the fact that when the phase (timing) of the spread code of the received base band signals coincides with the phase of the spread code produced inside the receiver, the correlation value between the spread code produced inside the receiver and the reception base band signal is at a maximum.

The digital receiver and measuring apparatus for measuring CDMA signals comprise a gate array, such as an ASIC or FPGA, operating as synchronization acquisition device (hereinafter called “acquisition device” ) and demodulation device. The signals under test are processed by the gate array. In particular, the measuring apparatus is often an FPGA because when compared to base stations and portable telephones, there are few on the market and there is demand for a plurality of uses. However, there are cases in which the processing time allowed for acquisition and the correlation length change with acquisition during the design steps of the gate array. Moreover, there are cases in which a device corresponding to a new CDMA system is developed using an existing product or platform. In these cases, the number of resources and operating clock frequency that can be used is generally or completely determined by the gate array. In general, a sliding correlator is capable of correlation processing with one multiplier and one adder, but the time needed for acquisition is long. Moreover, a matched filter performs high-speed acquisition, but a huge number of multipliers and adders are needed. Consequently, design efficiency is poor, and when responding to the above-mentioned types of changes, there are cases in which an acquisition device with the desired specifications cannot be satisfactorily used with the gate array scheduled for use and there is no room to change the gate array itself or the frequency of the operating clock of the gate array. Therefore, there is a need to provide an acquisition device with a more flexible selection than in the past of the number of gate array resources and of the operating clock frequency of the gate array when realizing an acquisition device with the desired specifications in a gate array. Moreover, measuring apparatuses often comprise not only an acquisition device and demodulator, but also the same gate array as the equipment necessary for measurement. Measuring devices are expected to conduct measurements of as many items as possible simultaneously and there is a demand for a reduction in the resource consumption of each device in a gate array.

### SUMMARY OF THE INVENTION

The present invention is intended to solve the above-mentioned problems. That is, the first subject of the invention is a gate array programming device for programming a reconfigurable gate array comprised in a measuring apparatus, this gate array programming device being characterized in that the gate array is programmed so as to function as a pseudo-noise code generator for generating K number of second pseudo-noise codes, each of different phases, which are the same code sequences as first pseudo-noise codes contained in signals under test; a selector, wherein the candidates for selection are two or more M number of second pseudo-noise codes from among the K number of second pseudo-noise codes, there are two or more N number of selectors for selecting and outputting one of the second pseudo-noise codes from the candidates for selection, and the second pseudo-noise codes that are from the candidates for selection of a certain selector are outside the candidates for selection of the other selectors; a multiplier, wherein there are N number of multipliers, each of which is connected to a respective selector, and the second pseudo-noise codes output by the corresponding selector are multiplied by the first pseudo-noise codes; an adder, wherein there are N number of adders, each of which is connected to a respective multiplier, and the multiplication results output by the corresponding multiplier are cumulatively added for each phase of the second pseudo-noise codes corresponding to the multiplication results; and a detector for detecting, as the phase of the first pseudo-noise codes, the phase of the second pseudo-noise codes corresponding to addition results for which the absolute value is at a maximum, or addition results exceeding a predetermined threshold value, from among the addition results of the adder; each selector selects the second pseudo-noise codes as the same chip data of the first pseudo-noise code are being supplied to the corresponding multiplier so that all of the second pseudo-noise codes that are candidates for selection are supplied to the corresponding multiplier; and the measuring apparatus can be synchronized with the first pseudo-noise codes.

The second subject of the invention is a gate array programming device for programming a reconfigurable gate array comprised in a measuring apparatus having a memory for storing signals under test and that operates on a clock that is faster than the chip rate of the signals under test, characterized in that the gate array is programmed so as to function as a pseudo-noise code generator for generating K number of second pseudo-noise codes, each of different phases, which are the same code sequences as first pseudo-noise codes contained in signals under test; a selector, wherein candidates for selection are two or more M number of second pseudo-noise codes from among the K number of second pseudo-noise codes, there are two or more N number of selectors for selecting and outputting one of the second pseudo-noise codes from candidates for selection, and the second pseudo-noise codes that are the candidates for selection of a certain selector are outside the candidates for selection of the other selectors; a multiplier, wherein there are N number of multipliers, each of which is connected to a respective selector, and the second pseudo-noise codes output by the corresponding selector are multiplied by the first pseudo-noise codes contained in the signals under test read from the memory; an adder, wherein there are N number of adders, each of which is connected to a respective multiplier, and the multiplication results output by the corresponding multiplier are cumulatively added for each phase of the second pseudo-noise codes corresponding to the multiplication results; and a detector for detecting, as the phase of the first pseudo-noise codes, the phase of the second pseudo-noise codes corresponding to addition results for which the absolute value is at a maximum, or addition results exceeding a predetermined threshold value, from among the addition results of the adder; each selector selects the second pseudo-noise codes as the same chip data of the first pseudo-noise code are being supplied to the corresponding multiplier so that all of the second pseudo-noise codes that are candidates for selection are supplied to the corresponding multiplier; and the measuring apparatus can be synchronized with the first pseudo-noise codes.

The third subject of the invention is the device of the first or second subjects of the invention, further characterized in that each of the selectors periodically and repeatedly selects the second pseudo-noise codes under a fixed order and timing, and each of the adders performs cumulative addition using a first delay unit having a time delay that is the same as the selection period of the second pseudo-noise codes in the corresponding selector.

The fourth subject of the invention is the device of any of the first through third subjects of the invention, further characterized in that the pseudo-noise code generator generates in parallel all of the second pseudo-noise codes through multiple second delay units based on a single third pseudo-noise code having the same code sequences as the first pseudo-noise codes.

The fifth subject of the invention is the device of the fourth subject of the invention, further characterized in that the third pseudo-noise code is a pseudo-noise code pre-stored in the memory region inside the gate array.

The sixth subject of the invention is the device of any of the first through fifth subjects of the invention, further characterized in that the M number can be different values for each programming of the gate array and the N number can be different values for each programming of the gate array.

The seventh subject of the invention is a measuring apparatus having a reconfigurable gate array, characterized in that the gate array is programmed so as to function as a pseudo-noise code generator for generating K number of second pseudo-noise codes, each of different phases, which are the same code sequences as a first pseudo-noise code contained in signals under test; a selector, wherein the candidates for selection are two or more M number of second pseudo-noise codes from among the K number of second pseudo-noise codes, there are two or more N number of selectors for selecting and outputting one of the second pseudo-noise codes from candidates for selection, and the second pseudo-noise codes that are candidates for selection of a certain selector are outside candidates for selection of the other selectors; a multiplier, wherein there are N number of multipliers, each of which is connected to a respective selector, and the corresponding second pseudo-noise codes output by the selector are multiplied by the first pseudo-noise codes; an adder, wherein there are N number of adders, each of which is connected to a respective multiplier, and the multiplication results output by the corresponding multiplier are cumulatively added for each phase of the second pseudo-noise codes corresponding to the multiplication results; and a detector for detecting, as the phase of the first pseudo-noise codes, the phase of the second pseudo-noise codes corresponding to addition results for which the absolute value is at a maximum, or addition results exceeding a predetermined threshold value, from among the addition results of the adder; each selector selects the second pseudo-noise codes as the same chip data of the first pseudo-noise codes are being supplied to the corresponding multiplier so that all of the second pseudo-noise codes that are candidates for selection are supplied to the corresponding multiplier; and the measuring apparatus can be synchronized with the first pseudo-noise codes.

The eighth subject of the invention is a measuring apparatus having a memory for storing signals under test and a reconfigurable gate array that operates by a clock that is faster than the chip rate of the signals under test, characterized in that the gate array is programmed so as to function as a pseudo-noise code generator for generating K number of second pseudo-noise codes, each of different phases, which are the same code sequences as a first pseudo-noise code included in signals under test; a selector, wherein the candidates for selection are two or more M number of second pseudo-noise codes from among the K number of second pseudo-noise codes, there are two or more N number of selectors for selecting and outputting one of the second pseudo-noise codes from candidates for selection, and the second pseudo-noise codes that are candidates for selection of a certain selector are outside the candidates for selection of the other selectors; a multiplier, wherein there are N number of multipliers, each of which is connected to a respective selector, and the second pseudo-noise code output by the corresponding selector is multiplied by the first pseudo-noise code contained in the signals under test read from the memory; an adder, wherein there are N number of adders, each of which is connected to a respective multiplier, and the multiplication results output by the corresponding multiplier are cumulatively added for each phase of the second pseudo-noise codes corresponding to the multiplication results; and a detector for detecting, as the phase of the first pseudo-noise codes, the phase of the second pseudo-noise codes corresponding to addition results for which the absolute value is at a maximum, or addition results exceeding a predetermined threshold value, from among the addition results of the adder; each selector selects the second pseudo-noise codes as the same chip data of the first pseudo-noise codes are being supplied to the corresponding multiplier so that all of the second pseudo-noise codes that are candidates for selection are supplied to the corresponding multiplier; and the measuring apparatus can be synchronized with the first pseudo-noise codes.

The ninth subject of the invention is the apparatus of the seventh or eighth subjects of the invention, further characterized in that each of the selectors periodically and repeatedly selects the second pseudo-noise codes under a fixed order and timing, and each of the adders performs cumulative addition using a first delay unit having a time delay that is the same as the selection period of the second pseudo-noise code in the corresponding selector.

The tenth subject of the invention is the apparatus of any of the seventh through ninth subjects of the invention, further characterized in that the pseudo-noise code generator generates in parallel all of the second pseudo-noise codes through multiple second delay units based on a single third pseudo-noise code having the same code sequences as the first pseudo-noise codes.

The eleventh subject of the invention is the apparatus of the tenth subject of the invention, further characterized in that the third pseudo-noise code is a pseudo-noise code pre-stored in the memory region inside the gate array.

The twelfth subject of the invention is the apparatus of any of the seventh through the eleventh subjects of the invention, further characterized in that the M number can be different values for each programming of the gate array and the N number can be different values for each programming of the gate array.

The thirteenth subject of the invention is a program for programming a reconfigurable gate array such that a measuring apparatus is synchronized with the first pseudo-noise codes contained in signals under test, wherein the measuring apparatus having the gate array, wherein the computer being a part of or being connected to a measuring apparatus, characterized in that the programmed gate array functions as a pseudo-noise code generator for generating K number of second pseudo-noise codes, each of different phases, which are the same code sequences as a first pseudo-noise code included in signals under test; a selector, wherein the candidates for selection are two or more M number of second pseudo-noise codes from among the K number of second pseudo-noise codes, there are two or more N number of selectors for selecting and outputting one of the second pseudo-noise codes from candidates for selection, and the second pseudo-noise codes that are candidates for selection of a certain selector are outside candidates for selection of the other selectors; a multiplier, wherein there are N number of multipliers, each of which is connected to a respective selector, and the corresponding second pseudo-noise code output by the selector is multiplied by the first pseudo-noise codes; an adder, wherein there are N number of adders, each of which is connected to a respective multiplier, and the multiplication results output by the corresponding multiplier are cumulatively added for each phase of the second pseudo-noise codes corresponding to the multiplication results; and a detector for detecting, as the phase of the first pseudo-noise codes, the phase of the second pseudo-noise codes corresponding to addition results for which the absolute value is at a maximum, or addition results exceeding a predetermined threshold value, from among the addition results of the adder; and each selector selects the second pseudo-noise code as the same chip data of the first pseudo-noise codes are being supplied to the corresponding multiplier so that all of the second pseudo-noise codes that are candidates for selection are supplied to the corresponding multiplier.

The fourteenth subject of the invention is a program for programming a reconfigurable gate array such that a measuring apparatus is synchronized with the first pseudo-noise codes contained in signals under test, wherein said measuring apparatus having the gate array, wherein the computer being a part of or being connected to a measuring apparatus, characterized in that the programmed gate array functions as a pseudo-noise code generator for generating K number of second pseudo-noise codes, each of different phases, which are the same code sequences as a first pseudo-noise code included in signals under test; a selector, wherein the candidates for selection are two or more M number of second pseudo-noise codes from among the K number of second pseudo-noise codes, there are two or more N number of selectors for selecting and outputting one of the second pseudo-noise codes from candidates for selection, and the second pseudo-noise codes that are candidates for selection of a certain selector are outside candidates for selection of the other selectors; a multiplier, wherein there are N number of multipliers, each of which is connected to a respective selector, and the second pseudo-noise code output by the corresponding selector is multiplied by the first pseudo-noise code contained in the signals under test read from the memory; an adder, wherein there are N number of adders, each of which is connected to a respective multiplier, and the multiplication results output by the corresponding multiplier are cumulatively added for each phase of the second pseudo-noise codes corresponding to the multiplication results; and a detector for detecting, as the phase of the first pseudo-noise codes, the phase of the second pseudo-noise codes corresponding to addition results for which the absolute value is at a maximum, or addition results exceeding a predetermined threshold value, from among the addition results of the adder; and each selector selects the second pseudo-noise code as the same chip data of the first pseudo-noise codes are being supplied to the corresponding multiplier so that all of the second pseudo-noise codes that are candidates for selection are supplied to the corresponding multiplier.

The fifteenth subject of the invention is the program of the thirteenth or fourteenth subjects of the invention, further characterized in that each of the selectors periodically and repeatedly selects the second pseudo-noise codes under a fixed order and timing, and each of the adders performs cumulative addition using a first delay unit having a time delay that is the same as the selection period of the second pseudo-noise code in the corresponding selector.

The sixteenth subject of the invention is the program of any of the thirteenth through the fifteenth subjects of the invention, further characterized in that the pseudo-noise code generator generates in parallel all of the second pseudo-noise codes through multiple second delay units based on a single third pseudo-noise code having the same code sequences as the first pseudo-noise codes.

The seventeenth subject of the invention is the program of the sixteenth subject of the invention, further characterized in that the third pseudo-noise code is a pseudo-noise code pre-stored in the memory region inside the gate array.

The eighteenth subject of the invention is the program of any of the thirteenth through seventeenth subjects of the invention, further characterized in that the M number can be different values for each programming of the gate array and the N number can be different values for each programming of the gate array.

By means of the present invention, the correlation function necessary for acquisition is performed by parallel time-division multiplexing; therefore, it is possible to provide an acquisition device with more flexible selection than in the past of the number of gate array resources and of the operating clock frequency of the gate array when realizing an acquisition device with the desired specifications in a gate array. For instance, it is possible to increase the degree of multiplexing and reduce the degree of parallelism in order to control resource consumption in a gate array scheduled for use. Moreover, it is possible to increase the degree of parallelism and reduce the degree of multiplexing for high-speed correlation processing in a gate array scheduled for use. The degree of parallelism and the degree of multiplexing can be adjusted such that correlation processing is performed at the most effective speed under a pre-determined operating clock frequency of the gate array. Selection with such flexibility makes it possible to use the gate array scheduled for use more effectively than in the past.

Moreover, the present invention uses a combination of periodic switching of a pseudo-noise code and cumulative adding using a delay unit; therefore, the cumulative addition for obtaining each correlation result can be conducted with a simple circuit structure.

By means of the present invention, the base pseudo-noise code is stored in a memory means and pseudo-noise codes of various phases are created simply using this pseudo-noise code and multiple delay units; therefore, multiple pseudo-noise codes, each of different phases, can be created by a simple structure. Moreover, there is also the effect of preventing consumption of the logic resources of the gate array. An example of logic resources is the logic cell of an FPGA.

### BRIEF DESCRIPTION OF THE DRAWINGS

FIG. 1 is a drawing showing the structure of measuring apparatuses 1, 2, and 3.

FIG. 2 is a drawing showing the structure of acquisition device 200.

FIG. 3 is a drawing showing the structure of ASR 250-1.

FIG. 4 is the timing chart relating to the data inside acquisition device 200.

FIG. 5 is a drawing showing the structure of acquisition device 400.

FIG. 6 is a drawing showing the structure of ASR 450-1.

FIG. 7 is a timing chart relating to the data inside acquisition device 400.

FIG. 8 is a drawing showing the structure of acquisition device 600.

FIG. 9 is a timing chart relating to the data inside acquisition device 600.

FIG. 10 is a drawing showing the structure of detector 690.

FIG. 11 is a drawing showing the structure of detector 790.

### DETAILED DESCRIPTION OF THE PREFERRED EMBODIMENT

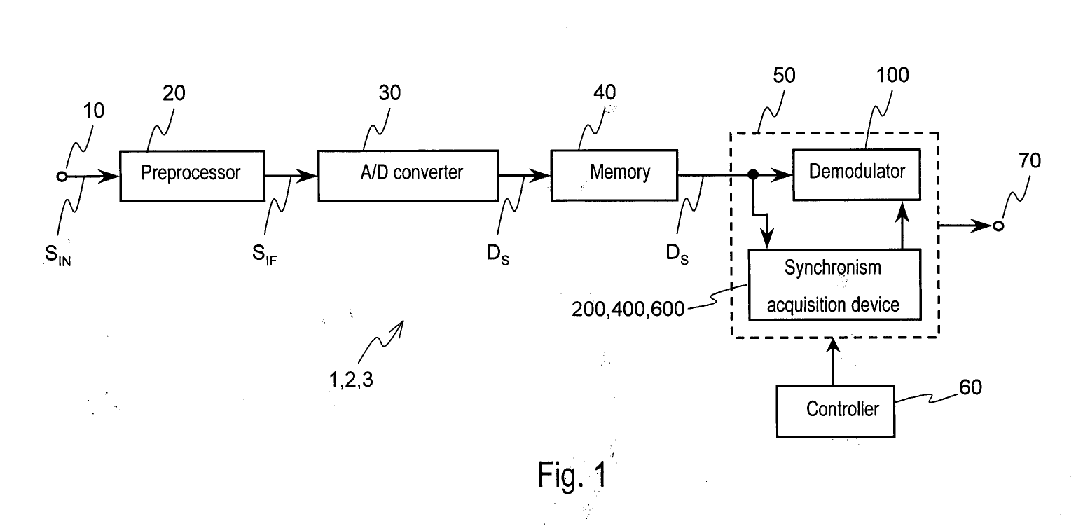

Embodiments of the present invention will be described while referring to the attached drawings. The first embodiment of the present invention is a measuring apparatus 1 for measuring the signals of a CDMA system, which are the signals under test. FIG. 1 is a block diagram showing the internal structure of a measuring apparatus 1. The structure of measuring apparatus 1 will be described first. Measuring apparatus 1 comprises an input terminal 10, a preprocessor 20, an analog-to-digital converter 30, a memory 40, a gate array 50, a controller 60, and an output terminal 70. The analog-to-digital converter is abbreviated as A/D converter in the present text.

Input terminal 10 is the terminal for receiving signal under test SIN. Signal under test SIN is a signal of a CDMA system, and includes a pseudo-noise code (PN code). Examples of signal under test S_{IN} are IS-95 system signals, W-CDMA system signals, and CDMA2000 system signals. Preprocessor 20 is the device for performing the predetermined signal processing on signal SIN that is received at input terminal 10. For instance, preprocessor 20 eliminates signals other than those that are the candidates for measurement contained in the signals under test S_{IN} and converts the frequency and the level of the signals under test S_{IN} in order to facilitate the processing of signals under test S_{IN} by the other devices. Signals under test S_{IN} that have been processed by preprocessor 20 are output from preprocessor 20 as signals under test S_{IF}. A/D converter 30 samples signals S_{IF} that are output from preprocessor 20 at a predetermined time interval, performs digital conversion of the sampled signals, and outputs the conversion results. The sampling rate is the same as the chip rate of signals under test S_{IN}. Of course, it is possible to over-sample at a rate that is two or more times faster than the chip rate. The chip is bits of pseudo-noise code contained in the signals under test S_{IN}. Moreover, the chip rate is the rate at which the pseudo-noise code contained in the signals under test S_{IN} changes, that is, the bit rate. Signals S_{IF} that have been digitally converted by A/D converter 30 are output as data D_{S} from A/D converter 30. Memory 40 is the device for storing the conversion results Dₛ of A/D converter 30. Memory 40 has access capability so that it is capable of storing data Dₛ without delay. A semiconductor memory such as a DRAM or SRAM is used for memory device 40. Gate array 50 is a gate array that forms a predetermined processing circuit by writing of data from controller 60, and is a reconfigurable gate array such as an FPGA. Examples of processing circuits are acquisition devices, demodulators, and BER measuring apparatuses. Gate array 50 processes data stored in memory 40. Data D_{S} stored in memory 40 can also be read from memory 40 by gate array 50 itself, and it can be read from memory 40 by controller 60 for gate array 50. Once the amount of data that has been accumulated in memory 40 reaches a certain point, the accumulated data can be transmitted to gate array 50 from memory 40, or memory 40 can be used as a buffer to absorb the difference between the output rate of A/D converter 30 and gate array 50. The predetermined amount of data is, for instance, n frames worth of data. The predetermined amount of data is n times of 38,400 chips in the case of a W-CDMA in which the period of the spread-spectrum code is 38,400 chips. Here, n is a natural number. There are many cases in which there is a difference between the output data rate of A/D converter 30 and the operating frequency of gate array 50; therefore, memory 40 is used to improve the flexibility of design of the measuring apparatus. Controller 60 is a so-called computer, and is the device for performing a predetermined operation or processing by execution of a program. Controller 60 controls the above-mentioned data access as well as the other devices inside the same measuring apparatus. Controller 60 can be a device that has functions corresponding to a computer; therefore, it is not limited to a computer system having peripheral equipment, a display, and other peripherals, and can be a processor such as a CPU or DSP, or a computer board. Output terminal 70 is a terminal for outputting the processing results of gate array 50.

Gate array 50 comprises a demodulator 100 and an acquisition device 200. Controller 60 programs gate array 50 so that demodulator 100 and acquisition device 200 are inside gate array 50. Gate array 50 is programmed by controller 60 as a result of controller 60 writing the data directly to gate array 50, or controller 60 writing data to a memory that is not illustrated but is connected from the outside to gate array 50. Moreover, controller 60 programs gate array 50 as a result of controller 60 executing a program that provides the instructions for the operation of controller 60 itself. The program that provides the instructions for the operation of controller 60 itself is stored in a storage medium that is permanently installed in controller 60, a removable storage medium inside controller 60, or an outside storage medium that is connected by wires or wireless to controller 60. Examples of such storage media are a hard disk drive or semiconductor memory inside controller 60, a removable semiconductor memory device or CD-ROM inside controller 60, or a hard disk drive or a server for downloading connected to controller 60 by a USB, a network, or another transmission medium. Acquisition device 200 is a device for detecting the phase of the pseudo-noise code contained in signals under test S_{IN}. Demodulator 100 is the device for demodulating signals under test S_{IN} (actually, data D_{S}) based on the phase detected by acquisition device 200.

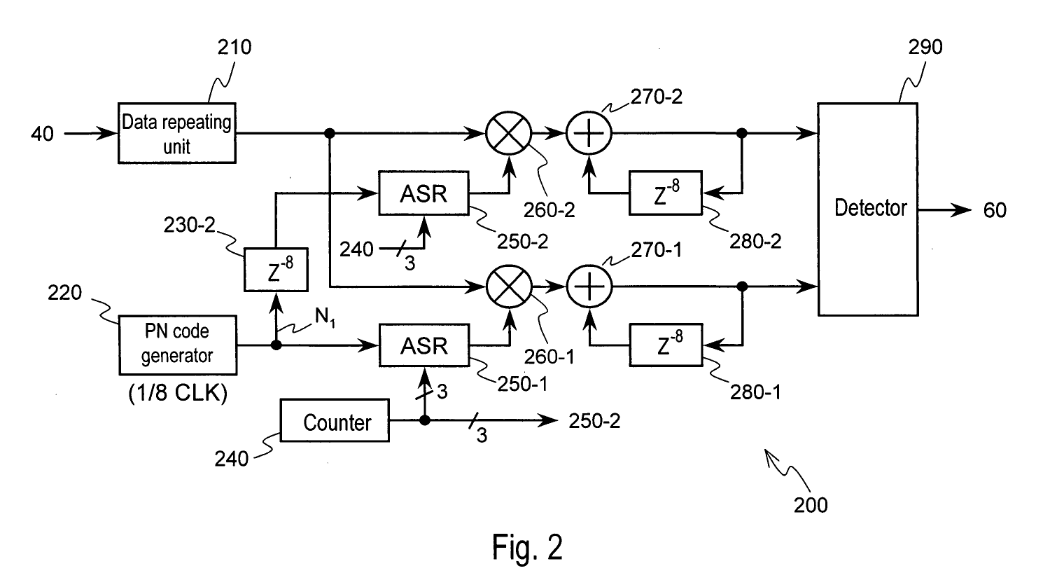

Refer to FIG. 2. FIG. 2 is a block diagram showing the internal structure of acquisition device 200. Acquisition device 200 comprises a data repeating unit 210, a PN code generator 220, a delay unit 230-2, a counter 240, an ASR 250-1, an ASR 250-2, a multiplier 260-1, a multiplier 260-2, an adder 270-1, an adder 270-2, a delay unit 280-1, a delay unit 280-2, and a detector 290.

Data repeating unit 210 is the device that operates in accordance with the clock signals CLK supplied to gate array 50 or signals obtained by dividing the frequency of clock signals CLK and continuously outputs data D_{S} that have been read from memory 40 under a time that is 8-times one period T_{C} of clock signals CLK. It should be noted that the rate of clock signals CLK is faster than the chip rate of signals under test S_{IN}, and is, for instance, several 100 MHz. The maximum rate of clock signals CLK is generally determined by the maximum operating clock frequency of the hardware, such as gate array 50. PN code generator 220 is the device for generating a pseudo-noise code N₁ one bit every 8 T_{C}. Pseudo-noise code N₁ is the pseudo-noise code necessary for each communications system, such as an M series or a gold code. Pseudo-noise code N, generated by PN code generator 220 is generated by repeating all or part of one period of pseudo-noise code contained in signal under test S_{IN}. In the case of complete correlation, all of the period in question is generated, and in the case of partial correlation, part of the period in question is generated. In order to simplify the explanation, a complete correlation of the correlation length of 16 bits is performed in the present embodiment, the code length of the pseudo-noise code contained in signal under test S_{IN} is 16 bits, and PN code generator 220 repeatedly generates a pseudo-noise code with a length of 16 bits. Delay units 230-2, 280-1, and 280-2 are elements for adding a time delay of 8 T_{C} to the input signals or input data and outputting the result. Delay units 230-2, 280-1, and 280-2 are, for instance, a shift register, an FIFO memory, or a transmission line of a predetermined length. Counter 240 is a 3-bit wide binary up counter and outputs numbers in order from 0 to 7. Counter 240 counts the clock signals CLK in intervals of one period in response to clock signals CLK. The counting results of counter 240 are given as address information to ASR 250-1 and ASR 250-2, respectively. The respective ASR250-1 and ASR250-2 are both addressable shift registers. ASR is the abbreviation for addressable shift register.

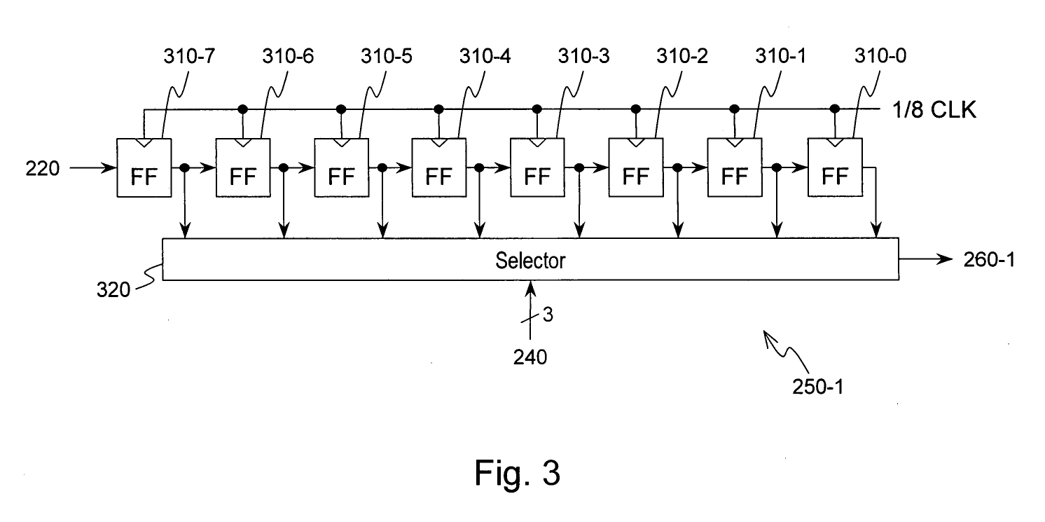

Refer to FIG. 3. FIG. 3 is a block diagram showing the internal structure of ASR 250-1. ASR 250-1 has 8 flip-flops 310-0 through 7 and a selector 320. The eight flip-flops 310-0-7 comprise the shift register. Flip-flop 310-7 captures the output data from PN code generator 220 and outputs the captured data in response to signals that have been obtained by dividing the frequency of clock signals CLK by 8. Each of the flip-flops 310-0 through 6 capture output data from the preceding flip-flop and outputs those data in response to signals obtained by dividing the frequency of clock signal CLK by 8. Selector 320 receives address information with a width of 3 bits from counter 240. Selector 320 selects one of the output data values from flip-flop 310-0 through 7 based on the address information from counter 240 and outputs the selected data value. The address information (address value) from counter 240 corresponds to the branch number of the reference number of the selected flip-flop. For instance, when the address information from counter 240 is 1, flip-flop 310-1 is selected. The pseudo-noise code is selected by periodic repetition under a fixed order and timing. The selected data are fed to multiplier 260-1 as the output of ASR 250-1.

Refer to FIG. 2. ASR 250-2 has the same structure and function as ASR 250-1 and a detailed description is therefore omitted. Multiplier 260-1 is the device for multiplying the output data of ASR 250-1 with the output data of data repeating unit 210 and outputting the multiplication results. Multiplier 260-2 is the device for multiplying the output data of ASR 250-2 with the output data of data repeating unit 210 and outputting the multiplication results. Adder 270-1 is the device for adding the output data of multiplier 260-1 and the output data of delay unit 280-1 and outputting the addition results. Adder 270-2 is the device for adding the output data of multiplier 260-2 and the output data of delay unit 280-2 and outputting the addition results. Adder 270-1 and delay unit 280-1 comprise a cumulative adder. Adder 270-2 and delay unit 280-2 comprise a cumulative adder. Detector 290 is the device for referring to the output data of adder 270-1 and adder 270-2 and detecting the phase of the pseudo-noise code contained in signal under test S_{IN}.

The operation of measuring apparatus 1 will now be described. Refer to FIG. 1. Signal under test S_{IN} is processed by preprocessor 20, the signal is then digitally converted by A/D converter 30, and the result is stored in memory 40. Acquisition device 200 detects the phase of the pseudo-noise code contained in signal under test S_{IN} based on data D_{S} stored in memory 40. Finally, demodulator 100 modulates signal under test S_{IN} (actually data D_{S}) based on the phase detected by acquisition device 200.

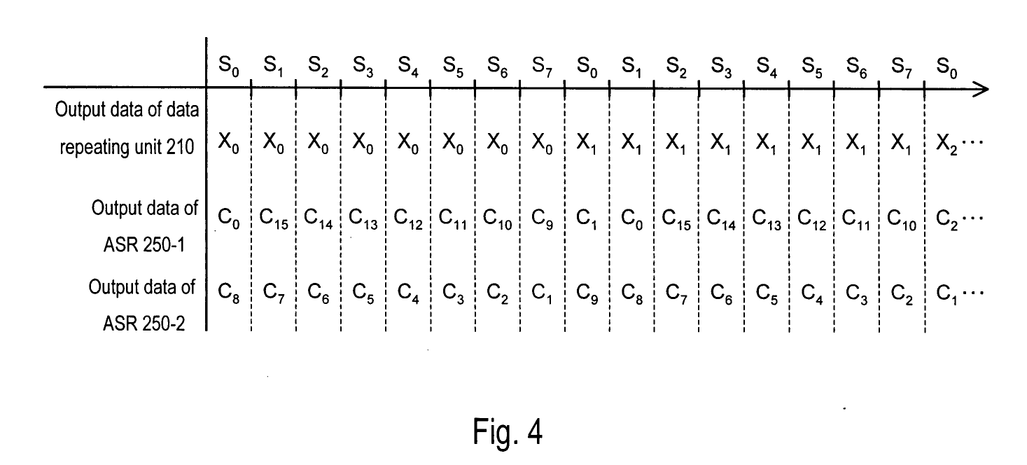

The operation of acquisition device 200 will now be described. Refer to FIGS. 2 and 4. FIG. 4 is the timing chart showing the output data of data repeating unit 210, the output data of ASR 250-1, and the output data of ASR 250-2. The x-axis in FIG. 4 is time. The vertical broken lines in FIG. 4 run along the period interval of clock signal CLK. The letters “S” with subscripts represent the time slots. The time interval of the time slot is T_{C}. The letters “X” with subscripts represent the output data of data repeating unit 210. The output data of data repeating unit 210 outputs new bit data every 8 T_{C}. The letters “C” with subscripts represent the bit data of pseudo-noise code N₁. The subscripts of the letters “C” represent the order of the bit data output from PN code generator 220. That is, data are output on the order of C₀, C₁, C₂, and so forth. It should be noted that because pseudo-noise code N₁ is repeatedly generated, C₀ is output after C₁₅. ASR260-1 and ASR 260-2 output the results of time-division multiplexing of 8 types of pseudo-noise codes with different phases. The 8 types of pseudo-noise codes that are output from ASR 260-1 have a phase that is different from the 8 pseudo-noise codes output from ASR 260-2. It goes without saying that the phase in this case is the phase of pseudo-noise code N₁. Multiplication processing is performed by multiplier 260-1 and then multiplier 260-2. Moreover, adder 270-1 adds the output data of adder 270-1 before 8 T_{C} to the multiplication results of multiplier 260-1 and outputs the addition results. That is, adder 270-1 performs cumulative addition of the multiplication results of multiplier 260-1 for every time slot. On the other hand, adder 270-2 adds the output data of adder 270-2 before 8 T_{C} to the multiplication results of multiplier 260-2 and outputs the addition results. That is, adder 270-2 performs cumulative addition of the multiplication results of multiplier 260-2 for every time slot.

The results of cumulative addition of the multiplication results for all 16 bits of pseudo-noise code N₁ are output from adder 270-1 and adder 270-2 for each phase of pseudo-noise code N₁ a specific amount of time after starting the above-mentioned mathematical operation. For instance, result Y₀ of X₀·C₀+X₁·C₁+X₂·C₂+X₃·C₃+X₄·C₄+X₅·C₅+X₆·C₆+X₇·C₇+X₈·C₈+X₉·C₉+X₁₀·C₁₀+X₁₁·C₁₁+X₁₂·C₁₂+X₁₃·C₁₃+X₁₄·C₁₄+X₁₅·

C₁₅ is output from adder 270-1. Y₀ is the result of mathematical operation when the phase of the front chip of pseudo-noise code N₁ coincides with input data X₀. Moreover, Yₙ is the result of the cumulative addition of the multiplication results when the phase of the front chip of pseudo-noise code N₁ is shifted by n chips with respect to initial input data X₀. Then, 9 T_{C} after initiating the output of mathematical operation result Y₀, the result of

$${X}_{1} \cdot {C}_{0} + {X}_{2} \cdot {C}_{1} + {X}_{3} \cdot {C}_{2} + {X}_{4} \cdot {C}_{3} + {X}_{5} \cdot {C}_{4} + {X}_{6} \cdot {C}_{5} + {X}_{7} \cdot {C}_{6} + {X}_{8} \cdot {C}_{7} + {X}_{9} \cdot {C}_{8} + {X}_{10} \cdot {C}_{9} + {X}_{11} \cdot {C}_{10} + {X}_{12} \cdot {C}_{11} + {X}_{13} \cdot {C}_{12} + {X}_{14} \cdot {C}_{13} + {X}_{15} \cdot {C}_{14} + {X}_{16} \cdot {C}_{15}$$

that is, mathematical operation result Y₁ is output. Thus, the results Y₁ through Y₇ of mathematical operation are output from adder 270-1 in succession every 9 T_{C}. Once mathematical operation result Y₇ has been output, the result Y₈ of X₈·C₀+X₉·C₁+X₁₀·C₂+X₁₁·C₃+X₁₂·C₄+X₁₃·C₅+₁₄·C₆+X₁₅·C₇+X₁₆·C₈+X₁₇·C₉+X₁₈·C₁₀+X₁₉·C₁₁+X₂₀·C₁₂+X₂₁·C₁₃+X₂₂·C₁₄+X₂₃·C₁₅ is output from adder 270-2. Mathematical operation results Y₈ through Y₁₅ are output from adder 270-2 in succession every 9 T_{C} as described above. Incidentally,

$${Y}_{15} = {X}_{15} \cdot {C}_{0} + {X}_{16} \cdot {C}_{1} + {X}_{17} \cdot {C}_{2} + {X}_{18} \cdot {C}_{3} + {X}_{19} \cdot {C}_{4} + {X}_{20} \cdot {C}_{5} + {X}_{21} \cdot {C}_{6} + {X}_{22} \cdot {C}_{7} + {X}_{23} \cdot {C}_{8} + {X}_{24} \cdot {C}_{9} + {X}_{25} \cdot {C}_{10} + {X}_{26} \cdot {C}_{11} + {X}_{27} \cdot {C}_{12} + {X}_{28} \cdot {C}_{13} + {X}_{29} \cdot {C}_{14} + {X}_{30} \cdot {C}_{15}$$

The results of cumulative addition of the multiplication results for all 16 bits of pseudo-noise code N₁ can be used as the correlation value of signals under test S_{IN} (actually data D_{S}) and pseudo-noise code N₁. Moreover, cumulative addition results Y₀ through Y₁₅ are eventually obtained for all 16 bits as the correlation value for each phase of pseudo-noise code N₁. By means of the present embodiment, the 16 types of related correlation operations each having a different phase of pseudo-noise code N₁ are processed after parallelization and time multiplexing (degree of parallelization of 2, degree of time multiplexing of 8). When the present system is compared with a conventional sliding correlator, the circuit scale is doubled by parallelization, while processing speed is curtailed by ½ assuming that clock signal CLK is the same as the input data rate. Moreover, the circuit scale of the present system is ⅛ that of a conventional matched filter as a result of multiplexing, and the processing speed is increased by 8 times assuming that clock signal CLK is the same as the input data rate. As in the present embodiment, high-speed processing that is the same or faster than conventional methods can be performed when clock signal CLK is faster than the input data rate.

Detector 290 detects the maximum absolute value from the above-mentioned 16 cumulative addition results output from adders 270-1 and 270-2. The phase of pseudo-noise code N₁ related to the detected cumulative addition results is output to demodulator 100. Demodulator 100 demodulates signals under test S_{IN} (actually data D_{S}) based on the phase information output by acquisition device 200.

A second embodiment of the present invention will now be described. The second embodiment of the present invention is a measuring apparatus 2 for measuring CDMA system signals, which are the signals under test. Refer to FIG. 1. Measuring apparatus 2 is an apparatus wherein acquisition device 200 of measuring apparatus 1 has been replaced by an acquisition device 400. That is, there is no difference between measuring apparatus 1 and measuring apparatus 2 in terms of structure. The only difference is in the devices realized in gate array 50 through controller 60. The structural elements of measuring apparatus 2 that are the same as those of measuring apparatus 1 will not be described.

Controller 60 programs gate array 50 so that acquisition device 400 is inside gate array 50. Acquisition device 400 is the device for detecting the phase of pseudo-noise signals contained in signals under test S_{IN}. Demodulator 100 is the device for demodulating signals under test S_{IN} (actually data D_{S}) based on the phase detected by acquisition device 400.

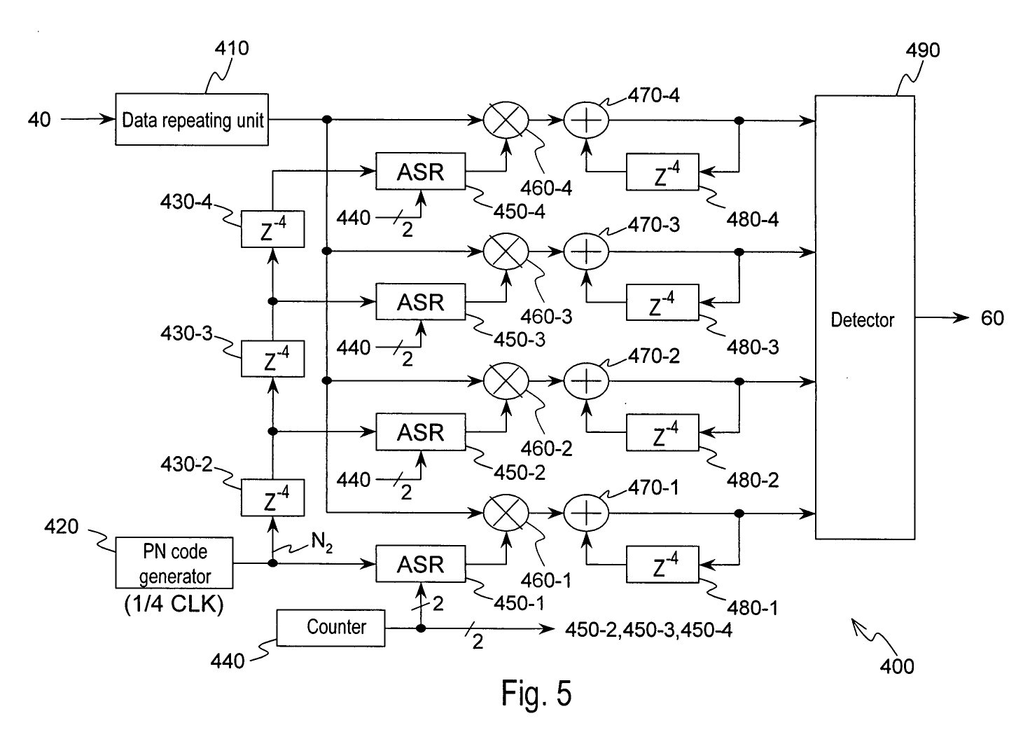

Refer to FIG. 5. FIG. 5 is a block diagram showing the internal structure of acquisition device 400. Acquisition device 400 comprises a data repeating unit 410, a PN code generator 420, a delay unit 430-2, a delay unit 430-3, a delay unit 430-4, a counter 440, an ASR 450-1, an ASR 450-2, an ASR 450-3, an ASR 450-4, a multiplier 460-1, a multiplier 460-2, a multiplier 460-3, a multiplier 460-4, an adder 470-1, an adder 470-2, an adder 470-3, an adder 470-4, a delay unit 480-1, a delay unit 480-2, a delay unit 480-3, a delay unit 480-4, and a detector 490.

Data repeating unit 410 is the device that operates in accordance with the clock signals CLK supplied to gate array 50 or signals obtained by dividing the frequency of clock signals CLK and continuously outputs data D_{S} that have been read from memory 40 under a time that is 4-times one period T_{C} of clock signals CLK. It should be noted that the rate of clock signals CLK is faster than the chip rate of signals under test S_{IN}, and is, for instance, several 100 MHz. The maximum rate of clock signals CLK is generally determined by the maximum operating clock frequency of the hardware, such as gate array 50. PN code generator 420 is the device for generating pseudo-noise code N₂ one bit every 4 T_{C}. Pseudo-noise code N₂ is the pseudo-noise code necessary for each communications system, such as an M series or a gold code. Pseudo-noise code N₂ generated by PN code generator 420 is generated by repeating all or part of one period of pseudo-noise code contained in signal under test S_{IN}. In the case of a complete correlation, all of the period in question is generated, and in the case of a partial correlation, part of the period in question is generated. In order to simplify the explanation, a complete correlation of the correlation length of 16 bits is performed in the present embodiment, the code length of the pseudo-noise code contained in signal under test S_{IN} is 16 bits, and PN code generator 420 repeatedly generates a pseudo-noise code with a length of 16 bits. Delay units 430-2 through 4 and delay bits 480-1 through 4 are elements for adding a time delay of 4 T_{C} to the input signals or input data and outputting the result. Delay units 430-2 through 4 and delay units 480-1 through 4 are, for instance, a shift register, an FIFO memory, or a transmission line of a predetermined length. Counter 440 is a 2-bit wide binary up counter and outputs numbers in order from 0 to 3. Counter 440 counts the clock signals CLK in intervals of one period in response to clock signals CLK. The counting results of counter 440 are given as address information to ASR 450-1 through 4, respectively. ASR 450-1 through 4 are addressable shift registers.

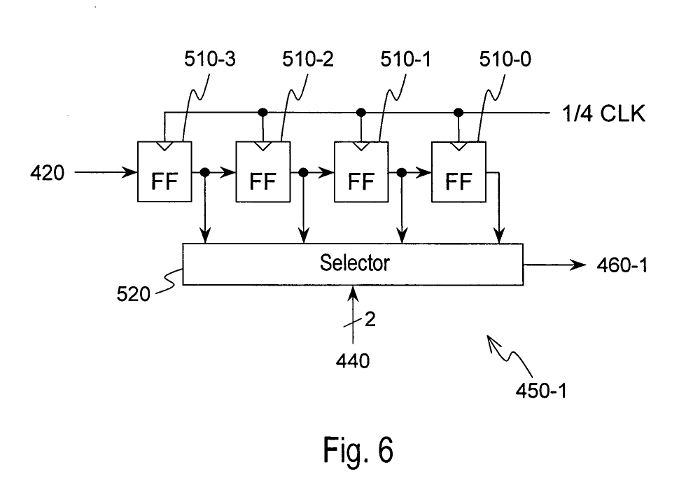

Refer to FIG. 6. FIG. 6 is a block diagram showing the internal structure of ASR 450-1. ASR 450-1 has four flip-flops 510-0 through 3 and a selector 520. The four flip-flops 510-0 through 3 comprise the shift register. Flip-flop 510-3 captures the output data from PN code generator 420 and outputs the captured data in response to signals that have been obtained by dividing the frequency of clock signals CLK by 4. Each of the flip-flops 510-0 through 2 capture output data from the preceding flip-flop and outputs those data in response to signals obtained by dividing the frequency of clock signal CLK by 4. Selector 520 receives address information with a width of 2 bits from counter 440. Selector 520 selects one of the output data values from flip-flop 510-0 through 3 based on the address information from counter 440 and outputs the selected data value. The selected data are fed to multiplier 460-1 as the output of ASR 450-1. The address information (address value) from counter 440 corresponds to the branch number of the reference number of the selected flip-flop. For instance, when the address information from counter 440 is 1, flip-flop 510-1 is selected.

Refer to FIG. 5. ASR 450-2 through 4 have the same structure and function as ASR 450-1 and a detailed description is therefore omitted. Multiplier 460-1 is the device for multiplying the output data of ASR 450-1 and the output data of data repeating unit 410 and outputting the multiplication results. Multiplier 460-2 is the device for multiplying the output data of ASR 450-2 with the output data of data repeating unit 410 and outputting the multiplication results. Multiplier 460-3 is the device for multiplying the output data of ASR 450-3 with the output data of data repeating unit 410 and outputting the multiplication results. Multiplier 460-4 is the device for multiplying the output data of ASR 450-4 with the output data of data repeating unit 410 and outputting the multiplication results. Adder 470-1 is the device for adding the output data of multiplier 460-1 and the output data of delay unit 480-1 and outputting the addition results. Adder 470-2 is the device for adding the output data of multiplier 460-2 and the output data of delay unit 480-2 and outputting the addition results. Adder 470-3 is the device for adding the output data of multiplier 460-3 and the output data of delay unit 480-3 and outputting the addition results. Adder 470-4 is the device for adding the output data of multiplier 460-4 and the output data of delay unit 480-4 and outputting the addition results. Adder 470-1 and delay unit 480-1 comprise a cumulative adder. Adder 470-2 and delay unit 480-2 comprise a cumulative adder. Adder 470-3 and delay unit 480-3 comprise a cumulative adder. Adder 470-4 and delay unit 480-4 comprise a cumulative adder. Detector 490 is the device for referring to the output data of adders 470-1 through 4 and detecting the phase of the pseudo-noise code contained in signal under test S_{IN}.

The operation of measuring apparatus 2 will now be described. Refer to FIG. 1. Signal under test S_{IN} is processed by preprocessor 20, the signal is then digitally converted by A/D converter 30, and the result is stored in memory 40. Acquisition device 400 detects the phase of the pseudo-noise code contained in signal under test S_{IN} based on data D_{S} stored in memory 40. Finally, demodulator 100 modulates signal under test S_{IN} (actually data D_{S}) based on the phase detected by acquisition device 400.

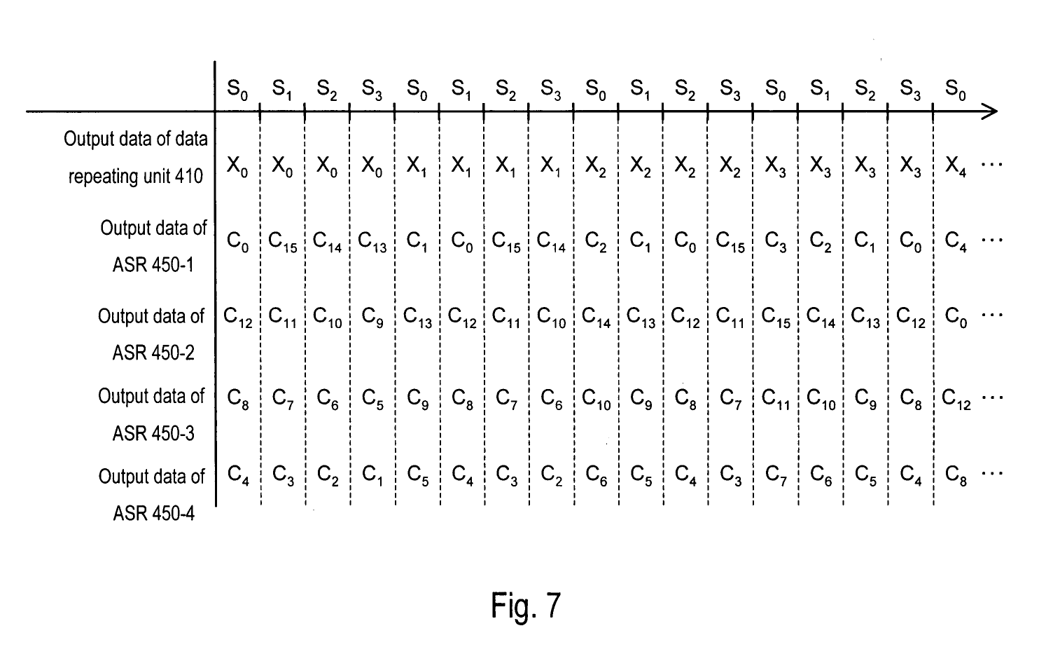

The operation of acquisition device 400 will now be described. Refer to FIGS. 5 and 7. FIG. 7 is the timing chart showing the output data of data repeating unit 410 and the output data of ASR 450-1 through 4. The x-axis in FIG. 7 is time. The vertical broken lines in FIG. 7 run along the period interval of clock signal CLK. The letters “S” with subscripts represent the time slots. The time interval of the time slot is T_{C}. The letters “X” with subscripts represent the output data of data repeating unit 410. The output data of data repeating unit 410 outputs new bit data every 4 T_{C}. The letters “C” with subscripts represent the bit data of pseudo-noise code N₂. The subscripts of the letters “C” represent the order of the bit data output from PN code generator 420. That is, data are output on the order of C₀, C₁, C₂, and so forth. It should be noted that because pseudo-noise code N₂ is repeatedly generated, C₀ is output after C₁₅. ASR 460-1 through 4 output the results of time-division multiplexing of four types of pseudo-noise codes with different phases. The 4 types of pseudo-noise codes that are output from a certain ASR have a phase that is different from the 4 types of pseudo-noise codes output from the other ASRs. The phase in this case is the phase of pseudo-noise code N₂. Multiplication processing is performed by multipliers 460-1 through 4 in succession. Adder 470-1 adds the output data of adder 470-1 before 4 T_{C} to the multiplication results of multiplier 460-1 and outputs the addition results. That is, adder 470-1 performs cumulative addition of the multiplication results of multiplier 460-1 for every time slot. Adder 470-2 adds the output data of adder 470-2 before 4 T_{C} to the multiplication results of multiplier 460-2 and outputs the addition results. That is, adder 470-2 performs cumulative addition of the multiplication results of multiplier 460-2 for every time slot. Adder 470-3 adds the output data of adder 470-3 before 4 T_{C} to the multiplication results of multiplier 460-3 and outputs the addition results. That is, adder 470-3 performs cumulative addition of the multiplication results of multiplier 460-3 for every time slot. Adder 470-4 adds the output data of adder 470-4 before 4 T_{C} to the multiplication results of multiplier 460-4 and outputs the addition results. That is, adder 470-4 performs cumulative addition of the multiplication results of multiplier 460-4 for every time slot.

The results of cumulative addition of the multiplication results for all 16 bits of pseudo-noise code N₂ are output from adders 470-1 through 4 for each phase of pseudo-noise code N₂ a specific amount of time after starting the above-mentioned mathematical operation. For instance, result Y₀ of

$${X}_{0} \cdot {C}_{0} + {X}_{1} \cdot {C}_{1} + {X}_{2} \cdot {C}_{2} + {X}_{3} \cdot {C}_{3} + {X}_{4} \cdot {C}_{4} + {X}_{5} \cdot {C}_{5} + {X}_{6} \cdot {C}_{6} + {X}_{7} \cdot {C}_{7} + {X}_{8} \cdot {C}_{8} + {X}_{9} \cdot {C}_{9} + {X}_{10} \cdot {C}_{10} + {X}_{11} \cdot {C}_{11} + {X}_{12} \cdot {C}_{12} + {X}_{13} \cdot {C}_{13} + {X}_{14} \cdot {C}_{14} + {X}_{15} \cdot {C}_{15}$$

is output from adder 470-1. Y₀ is the result of mathematical operation when the phase of the front chip of pseudo-noise code N₂ coincides with input data X₀. Moreover, Yₙ is the results of cumulative addition of the multiplication results when the phase of the front chip of pseudo-noise code N₂ is shifted by n chips with respect to initial input data X₀. Then, 5 T_{C}after initiating the output of mathematical operation results Y₀, the result of

$${X}_{1} \cdot {C}_{0} + {X}_{2} \cdot {C}_{1} + {X}_{3} \cdot {C}_{2} + {X}_{4} \cdot {C}_{3} + {X}_{5} \cdot {C}_{4} + {X}_{6} \cdot {C}_{5} + {X}_{7} \cdot {C}_{6} + {X}_{8} \cdot {C}_{7} + {X}_{9} \cdot {C}_{8} + {X}_{10} \cdot {C}_{9} + {X}_{11} \cdot {C}_{10} + {X}_{12} \cdot {C}_{11} + {X}_{13} \cdot {C}_{12} + {X}_{14} \cdot {C}_{13} + {X}_{15} \cdot {C}_{14} + {X}_{16} \cdot {C}_{15}$$

that is, mathematical operation result Y₁, is output. Thus, mathematical operation results Y₀ through Y₃ are output from adder 470-1 in succession every 5 T_{C}. Once mathematical operation result Y₃ has been output, the result Y₄ of

$${X}_{4} \cdot {C}_{0} + {X}_{5} \cdot {C}_{1} + {X}_{6} \cdot {C}_{2} + {X}_{7} \cdot {C}_{3} + {X}_{8} \cdot {C}_{4} + {X}_{9} \cdot {C}_{5} + {X}_{10} {C}_{6} + {X}_{11} \cdot {C}_{7} + {X}_{12} \cdot {C}_{8} + {X}_{13} \cdot {C}_{9} + {X}_{14} \cdot {C}_{10} + {X}_{15} \cdot {C}_{11} + {X}_{16} \cdot {C}_{12} + {X}_{17} \cdot {C}_{13} + {X}_{18} \cdot {C}_{14} + {X}_{19} \cdot {C}_{15}$$

is output from adder 470-2. Mathematical operation results Y₄ through Y₇ are output from adder 470-2 in succession every 5 T_{C} as described above. Once mathematical operation result Y₇ has been output, results Y₈ through Y₁₁ are output in succession every 5 T_{C} from adder 470-3. Once mathematical operation results Y₁₁ has been output, results Y₁₂ through Y₁₅ are output in succession every 5 T_{C} from adder 470-4.

The results of cumulative addition of the multiplication results for all 16 bits of pseudo-noise code N₂ can be used as the correlation value of signals under test S_{IN} (actually data D_{S}) and pseudo-noise code N₂. Moreover, cumulative addition results Y₀ through Y₁₅ are eventually obtained for all 16 bits as the correlation value for each phase of pseudo-noise code N₂. By means of the present embodiment, the 16 types of related correlation operations each having a different phase of pseudo-noise code N₂ are processed after parallelization and time multiplexing (degree of parallelization of 4, degree of time multiplexing of 4). When the present system is compared with a conventional sliding correlator, the circuit scale is increased 4-times by parallelization, while processing speed is curtailed by ¼ assuming that clock signal CLK is the same as the input data rate. Moreover, the circuit scale of the present system is ¼ that of a conventional matched filter as a result of multiplexing, and the processing speed is increased by 4-times assuming that clock signal CLK is the same as the input data rate. As in the present embodiment, high-speed processing that is the same or faster than conventional methods can be performed when clock signal CLK is faster than the input data rate.

Detector 490 detects the maximum absolute value from the above-mentioned 16 cumulative addition results output from adders 470-1 through 4. The phase of pseudo-noise code N₂ related to the detected cumulative addition results is output to demodulator 100. Demodulator 100 demodulates signals under test S_{IN} (actually data D_{S}) based on the phase information output by acquisition device 400.

Each of the above-mentioned embodiments have used a complete correlation. The present invention can use a complete or partial correlation for acquisition. Therefore, acquisition by partial correlation will be described below with a third embodiment of the present invention.

The third embodiment of the present invention is measuring apparatus 3 for measuring CDMA system signals, which are the signals under test. Refer to FIG. 1. A measuring apparatus 3 is an apparatus wherein acquisition device 200 of measuring apparatus 1 has been replaced by an acquisition device 600. That is, there is no difference between measuring apparatus 1 and measuring apparatus 3 in terms of structure. The only difference is in the devices realized in gate array 50 through controller 60. The structural elements of measuring apparatus 3 that are the same as those of measuring apparatus 1 will not be described.

Controller 60 programs gate array 50 so that acquisition device 600 is inside gate array 50. Acquisition device 600 is the device for detecting the phase of pseudo-noise signals contained in signals under test S_{IN}. Demodulator 100 is the device for demodulating signals under test S_{IN} (actually data D_{S}) based on the phase detected by acquisition device 600.

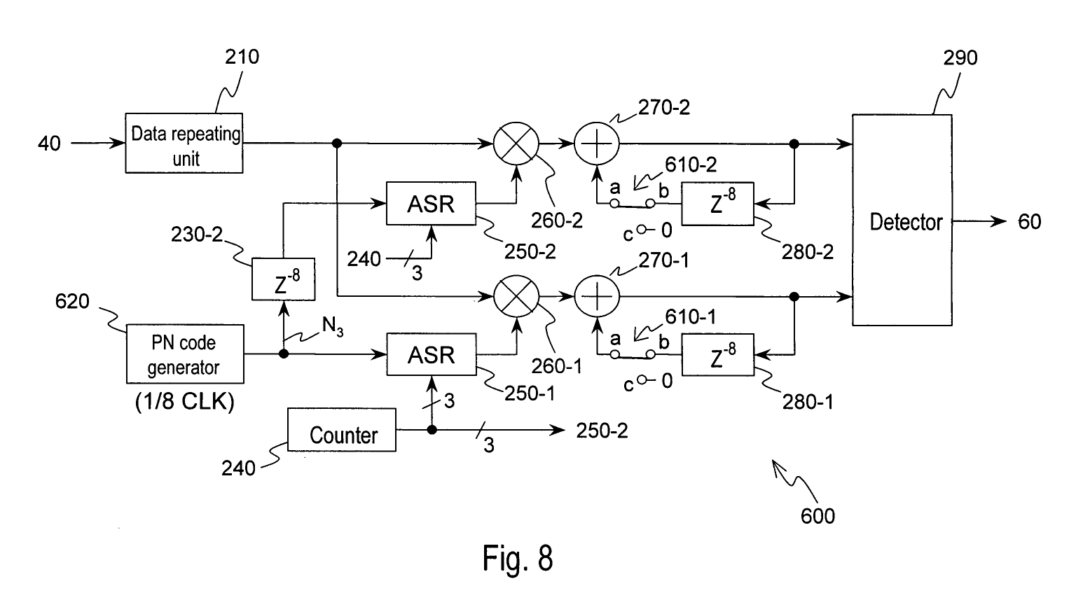

Refer to FIG. 8. FIG. 8 is a block diagram showing the internal structure of acquisition device 600. In addition to the structural elements of acquisition device 200, acquisition device 600 comprises a switch 610-1 between adder 270-1 and delay unit 280-1 and a switch 610-2 between adder 270-2 and delay unit 280-2. Switches 610-1 and 610-2 are single-pole, double-throw (SPDT) switches. Moreover, acquisition device 600 comprises a PN code generator 620 in place of PN code generator 220. The structural elements in FIG. 8 that are the same as in FIG. 2 are identified by the same symbols and will not be described in detail.

Terminal a is a common terminal in switches 610-1 and 610-2. Terminal a of switch 610-1 is connected to adder 270-1. Terminal b of switch 610-1 is connected to delay unit 280-1, and feeds the output data of delay unit 280-1. Terminal c of switch 610-1 feeds zero. Terminal a of switch 610-2 is connected to adder 270-2. Terminal b of switch 610-2 is connected to delay unit 280-2, and feeds the output data of delay unit 280-2. Terminal c of switch 610-2 feeds zero. Adder 270-1 adds the output data of multiplier 260-1 and the data that appears at terminal a of switch 610-1 and outputs the results. Adder 270-2 adds the output data of multiplier 260-2 and the data that appears at terminal a of switch 610-2 and outputs the results.

PN generator 620 is the device for generating pseudo-noise code N₃ one bit at a time every 8 T_{C}. Pseudo-noise code N₃ is the pseudo-noise code necessary for each communications system, such as an M series or a gold code. This pseudo-noise signal N₃ is part of a certain pseudo-noise code. By means of the present embodiment, a W-CDMA, wherein the period of the spread-spectrum code is 38,400 chips is used as an example, and pseudo-noise code N₃ generated by PN code generator 620 is the 16 bits from the front of a pseudo-noise code with a code length of 38,400 bits. Pseudo-noise code N₃ is repeatedly generated by PN code generator 620. Pseudo-noise code N₃ is supplied to ASR 250-1, and to ASR 250-2 through delay unit 230-2.

The operation of measuring apparatus 3 will now be described. Refer to FIG. 1. Signal under test S_{IN} is processed by preprocessor 20, the signal is then digitally converted by A/D converter 30, and the result is stored in memory 40. Acquisition device 600 detects the phase of the pseudo-noise code contained in signal under test S_{IN} based on data D_{S} stored in memory 40. Finally, demodulator 100 modulates signal under test S_{IN} (actually data D_{S}) based on the phase detected by acquisition device 600.

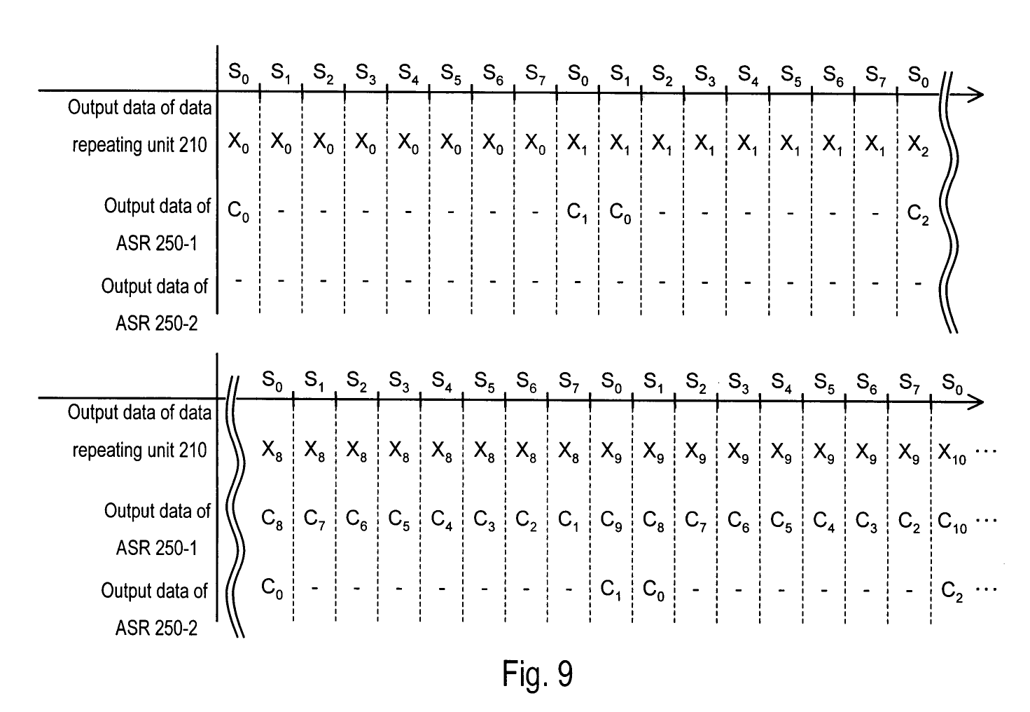

The operation of acquisition device 600 will now be described. Refer to FIGS. 8 and 9. FIG. 9 is the timing chart showing the output data of data repeating unit 210 and the output data of ASR 250-1 through 4. The x-axis in FIG. 9 is time. The vertical broken lines in FIG. 9 run along the period interval of clock signal CLK. The bottom half of FIG. 9 is a chart that is a time continuum of the top of FIG. 9. The letters “S” with subscripts represent the time slots. The time interval of the time slot is T_{C}. The letters “X” with subscripts represent the output data of data repeating unit 210. The output data of data repeating unit 410 outputs new bit data every 8 T_{C}. The letters “C” with subscripts represent the bit data of pseudo-noise code N₃. The subscripts of the letters “C” represent the order of the bit data output from PN code generator 220. That is, data are output on the order of C₀, C₁, C₂, and so forth. It should be noted that because pseudo-noise code N₃ is repeatedly generated, C₀ is output after C₁₅. Moreover, pseudo-noise code N₃ is part of a pseudo-noise code; therefore, cumulative addition in order beginning with the multiplication results with C₀ is necessary, and bit data until C₀ appears and the mathematical operation relating to those bit data are completely invalid. Such invalid bit data are represented by the “−” sign in the timing chart (FIG. 9).

Each of multipliers 260-1 and 260-1 and adders 270-1 and 270-2 continuously repeat the mathematical operation. Switches 610-1 and 610-2 perform the selection operation such that the multiplication results relating to the invalid bit data are not reflected in the cumulative addition processing. That is, switch 610-1 selects terminal c when the output data of ASR 250-1 related to the data (multiplication results) input to adder 270-1 are C₀. As a result, cumulative addition values relating to adder 270-1 are initialized. On the other hand, switch 610-1 selects terminal b when the output data of ASR 250-1 related to the data (multiplication results) input to adder 270-1 are data other than C₀. Moreover, switch 610-2 selects terminal c when the output data of ASR 250-2 related to the data (multiplication results) input to adder 270-2 are C₀. As a result, cumulative addition values relating to adder 270-2 are initialized. On the other hand, switch 610-2 selects terminal b when the output data of ASR 250-2 related to the data (multiplication results) input to adder 270-2 are data other than C₀. More specifically, terminal c of switch 610-1 is selected at time slot S₀ when the output data of data repeating unit 210 are X₀ and at time slot S₁ when the output data of data repeating unit 210 are X₁, and zero is fed to adder 270-1. Moreover, terminal b of switch 610-1 is selected at time slot S₀ when the output data of data repeating unit 210 are X₁ and at time slot S₁ when the output data of data repeating unit 210 are X₂, and the output data of delay unit 280-1 are fed to adder 270-1. In addition, for instance, terminal c of switch 610-2 is selected at time slot S₀ when the output data of data repeating unit 210 are X₈ and at time slot S₁ when the output data of data repeating unit 210 are X₉, and zero is supplied to adder 270-2. Moreover, terminal b of switch 610-2 is selected at time slot S₀ when the output data of data repeating unit 210 are X₉ and at time slot S₁ when the output data of data repeating unit 210 are X₁₀, and the output data of delay unit 280-2 are supplied to adder 270-2.

As in the first embodiment, the results of cumulative addition of multiplication results for all 16 bits of pseudo-noise code N₃ are output in succession from each adder 270-1 and adder 270-2 for each phase of pseudo-noise code N₃ once a certain amount of time has passed after resetting. Yₙ is the result of cumulative addition of the multiplication results when the phase of the front chip of pseudo-noise code N₃ has been shifted by n chips with regard to initial input data X₀. As in the first embodiment, each of the cumulative addition results is output by timing whereby mathematical results Y₀ through Y₇ are output in succession every 9 T_{C} from adder 270-1. Once Y₇ has been output, Y₈ through Y₁₅ are output in succession every 9 T_{C} from adder 270-2.

As previously described, switch 610-1 selects terminal c when the output data of ASR 250-1 relating to the data (multiplication results) input to adder 280-1 are C₀. Moreover, switch 610-2 selects terminal c when the output data of ASR 250-1 relating to the data (multiplication results) input to adder 280-1 are C₀. Cumulative addition values are initialized at all times by these operations. Consequently, once mathematical operation results Y₀ through Y₁₅ have been output, the cumulative addition values relating to each of mathematical operation results Y₀ through Y₁₅ are initialized and new cumulative addition begins. Moreover, mathematical operation results Y₁₆-Y₂₃ are output in succession every 9 T_{C} from adder 270-2. Once Y₂₃ has been output, Y₂₄ through Y₃₁ are output in succession every 9 T_{C} from adder 270-2. When one new cumulative addition starts, the search field expands by one chip. It is possible to perform partial correlation processing in a field with a total length of 38,400 chips of a pseudo-noise code used in, for instance, the signal spread of W-CDMA by expanding the search field in this way.

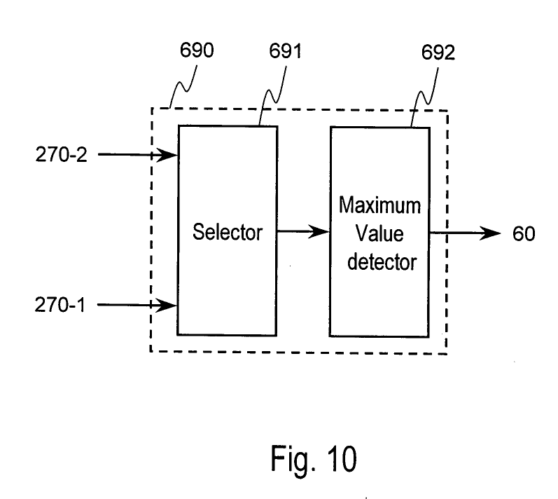

Each cumulative addition result is output at a different time. Therefore, detector 290 can be replaced by a detector 690 shown in FIG. 10. Refer to FIG. 10. FIG. 10 shows an example of the internal structure of detector 690. Detector 690 comprises a selector 691 for selecting and outputting either the output data of adder 270-1 or the output data of adder 270-2, and a maximum value detector 692 for detecting the data with the maximum absolute value from the output data of selector 691 and outputting the phase of pseudo-noise code N₃ corresponding to that maximum value. This type of detector 690 has a simplified structure in that two maximum value detectors corresponding to the adders are not necessary and there is little consumption of the gate array resources.

Moreover, the means for initializing the cumulative addition value is limited to switches in the third embodiment. It is also possible to use means whereby when the data of the pseudo-noise code corresponding to the multiplication results supplied to an adder are the data at the front of that pseudo-noise code, those multiplication results and the data input to the adder are brought to zero. For instance, when the delay unit connected to an adder comprised of shift registers in the same number of steps as those housed inside the corresponding ASR, a controller can be used in place of the switch so that a pre-determined flip-flop of the shift register is reset to the appropriate time based on the pseudo-noise code supplied to the multiplier.

Acquisition device 400 of the second embodiment can be modified so that correlation processing is performed using a partial pseudo-noise code as in the third embodiment. In addition, other modifications relating to the third embodiment are also possible.

Moreover, by means of each of the above-mentioned embodiments, the degree of time-division multiplexing and the degree of parallelization for correlation processing can be selected as needed. That is, the degree of time-division multiplexing is not limited to 8 and the degree of parallelization is not limited to 2 as in the first embodiment. Moreover, the degree of time-division multiplexing is not limited to 4 and the degree of parallelization is not limited to 4 as in the second embodiment. The correlation length is not limited to 16 bits. For instance, when the correlation length is 256 bits, it is possible to use a structure with a degree of parallelization of 16 and a degree of time-division multiplexing of 16; a structure of a degree of parallelization of 8 and a degree of time-division multiplexing of 32; or a degree of parallelization of 4 and a degree of time-division multiplexing of 64. In addition, any value can be selected as the degree of time-division multiplexing and the degree of parallelization for correlation processing for each program of gate array 50. Thus, changes in the degree of time-division multiplexing and the degree of parallelization are not limited by signals under test S_{IN}. For instance, it is possible to change the degree of time-division multiplexing or degree of parallelization during synchronization processing of signal under test S_{IN} and repeat synchronization processing. However, if the clock speed (or processing rate) of gate array 50 is higher than the chip rate or the sampling rate of signals under test S_{IF} (or S_{IN}), the degree of time-division multiplexing can be increased and the resource consumption of gate array 50 can be reduced. On the other hand, if the clock speed (or processing rate) of gate array 50 is relatively slow, it is possible to increase the degree of parallelization by using more of the resources of gate array 50 and select a degree of parallelization such that the necessary processing is performed in the necessary time. Consequently, in cases in which the signal-to-noise ratio of the signals under test deteriorates under conditions of limited correlation processing time and an increase in the correlation length becomes necessary, it is possible to change the degree of time-division multiplexing and/or the degree of parallelization of the acquisition device while taking into consideration the scale of the other devices in the same gate array. As is clear taking into consideration the first and second embodiments and the above-mentioned description, the degree of time-division multiplexing and the degree of parallelization of correlation processing can be changed in the same hardware structure and selected manually or automatically, as needed or in accordance with predetermined rules, from multiple combinations of degrees of time-division multiplexing and degrees of parallelization. It should be noted that when the same data of the signals under test are supplied to a certain multiplier, the degree of time-division multiplexing is the equivalent of the types of phase of pseudo-noise codes supplied to the same multiplier. The degree of parallelization equals the number of multipliers.

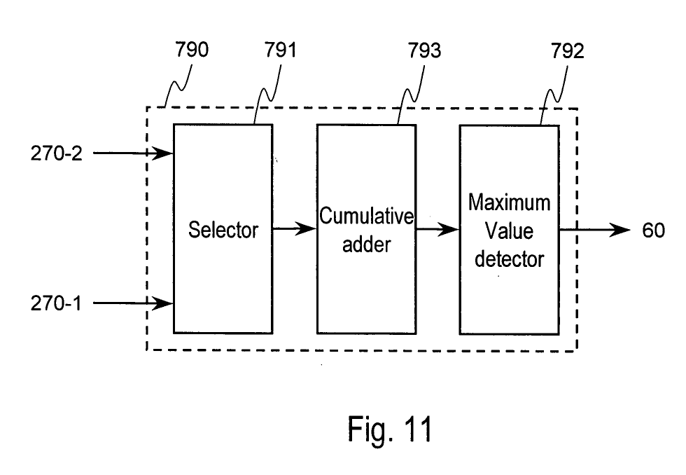

There are cases in the above-mentioned embodiment in which, when the signal-to-noise ratio (SNR) is small, the effect of the noise component increases and the correct phase of the pseudo-noise code contained in the signal under test S_{IN} cannot be detected. Moreover, by means of the third embodiment, the correlation length for partial correlation can be increased, but even then there are cases in which the correct phase cannot be detected. This type of problem is effectively alleviated in each of the embodiments by adding a circuit for further cumulative addition of the correlation values (cumulative addition results) obtained for each phase of the pseudo-noise code generated by the PN code generator for each period of the pseudo-noise code contained in the signals under test S_{IN}. As a result, it is possible to increase the SNR of the correlation values and detect the correct phase. For instance, when the third embodiment is modified, detector 690 in FIG. 8 can be replaced by a detector 790 shown in FIG. 11. FIG. 11 is a drawing showing an example of the internal structure of detector 790. Detector 790 comprises a selector 791 for selecting and outputting either the output data of adder 270-1 or the output data of adder 270-2; a cumulative adder 793 for cumulative addition of the output data of selector 791 for each period of the pseudo-noise code N₃ contained in signals under test S_{IN}, and a maximum value detector 792 for detecting the data with the maximum value from the data (cumulative correlation values) output-from cumulative adder 793 and outputting the phase of pseudo-noise code N₃ corresponding to this maximum value. The same holds true for the first and second embodiments.

The detector in each of the above-mentioned embodiments is structured so that it refers to the output data of the adder, but it can also refer to the output data of the delay unit connected to the adder for accumulation.

The detector in each of the above-mentioned embodiments detects the maximum absolute value of the cumulative addition results in order to detect the phase of the pseudo-noise code contained in the signals under test, but it is also possible to detect the cumulative addition results that exceed a predetermined level instead of detecting the maximum value.

Furthermore, the correlation length, the length of the pseudo-noise code contained in the signals under test S_{IN}, and the length of the pseudo-noise code generated by each code generator is not limited to 16 bits. For instance, these can be shorter than 16 bits or longer than 16 bits. For example, it is possible to use partial correlation of a 128-bit length corresponding to the signals under test that have been spread by a pseudo-noise code of 38,400 chips.

In each of the above-mentioned embodiments, it is possible to connect the PN generator to the memory region (not illustrated) inside gate array 50 or to gate array 50 and replace it with a memory capable of reading data at the same speed or a faster speed than inside gate array 50. That is, the desired pseudo-noise code data can be prestored in that memory region and the stored pseudo-noise code can be repeatedly accessed in order one bit at a time from this memory region.

Each of the structural elements of each of the above-mentioned embodiments may be contained in one housing or divided among two or more housings. For instance, controller 60 can be a commercial computer and the other structural elements can be part of one measuring apparatus connected to that computer. Moreover, those other structural elements can be on a board or a card that can be housed inside the commercial computer.

The present invention is beneficial not only for a reconfigurable gate array such as an FPGA, but also for a custom LSI-type gate array such as an ASIC.

What is claimed is:

1. A gate array programming device for programming a reconfigurable gate array comprised in a measuring apparatus, wherein said gate array programming device programs said gate array so that said gate array comprises:
a pseudo-noise code generator for generating K number of second pseudo-noise codes, each of different phases, which are the same code sequences as first pseudo-noise codes contained in signals under test;
a selector, wherein the candidates for selection are two or more M number of second pseudo-noise codes from among said K number of second pseudo-noise codes, there are two or more N number of selectors for selecting and outputting one of the second pseudo-noise codes from the candidates for selection, and the second pseudo-noise codes that are the candidates for selection of a certain selector are outside the candidates for selection of the other selectors;
a multiplier, wherein there are N number of multipliers, each of which is connected to a respective selector, and the second pseudo-noise codes output by the corresponding selector are multiplied by the first pseudo-noise codes;
an adder, wherein there are N number of adders, each of which is connected to a respective multiplier, and the multiplication results output by the corresponding multiplier are cumulatively added for each phase of the second pseudo-noise codes -corresponding to the multiplication results; and
a detector for detecting, as the phase of the first pseudo-noise codes, the phase of the second pseudo-noise codes corresponding to addition results for which the absolute value is at a maximum, or addition results exceeding a predetermined threshold value, from among the addition results of the adder;
wherein each selector selects the second pseudo-noise codes as the same chip data of the first pseudo-noise code are being supplied to the corresponding multiplier so that all of the second pseudo-noise codes that are candidates for selection are supplied to the corresponding multiplier; and the measuring apparatus is synchronized with the first pseudo-noise codes.

2. The gate array programming device according to claim 1, wherein each of the selectors periodically and repeatedly selects the second pseudo-noise codes under a fixed order and timing, and each of the adders performs cumulative addition using a first delay unit having a time delay that is the same as the selection period of the second pseudo-noise codes in the corresponding selector.

3. The gate array programming device according to claim 1, wherein said pseudo-noise code generator generates in parallel all of the second pseudo-noise codes through multiple second delay units based on a single third pseudo-noise code having the same code sequences as the first pseudo-noise codes.

4. The gate array program device according to claim 3, wherein said third pseudo-noise code is a pseudo-noise code pre-stored in the memory region inside said gate array.

5. The gate array program device according to claim 1, wherein said M number can be different values for each programming of the gate array and wherein said N number can be different values for each programming of the gate array.

6. A gate array programming device for programming a reconfigurable gate array comprised in a measuring apparatus having a memory for storing signals under test, wherein said gate array operating on a clock that is faster than the chip rate of the signals under test, wherein said gate array programming device programs said gate array so that said gate array comprises:
a pseudo-noise code generator for generating K number of second pseudo-noise codes, each of different phases, which are the same code sequences as first pseudo-noise codes contained in signals under test;
a selector, wherein candidates for selection are two or more M number of second pseudo-noise codes from among said K number of second pseudo-noise codes, there are two or more N number of selectors for selecting and outputting one of the second pseudo-noise codes from candidates for selection, and the second pseudo-noise codes that are the candidates for selection of a certain selector are outside the candidates for selection of the other selectors;
a multiplier, wherein there are N number of multipliers, each of which is connected to a respective selector, and the second pseudo-noise codes output by the corresponding selector are multiplied by the first pseudo-noise codes contained in the signals under test read from said memory;
an adder, wherein there are N number of adders, each of which is connected to a respective multiplier, and the multiplication results output by the corresponding multiplier are cumulatively added for each phase of the second pseudo-noise codes corresponding to the multiplication results; and
a detector for detecting, as the phase of the first pseudo-noise codes, the phase of the second pseudo-noise codes corresponding to addition results for which the absolute value is at a maximum, or addition results exceeding a predetermined threshold value, from among the addition results of the adder;
wherein each selector selects the second pseudo-noise codes as the same chip data of the first pseudo-noise code are being supplied to the corresponding multiplier so that all of the second pseudo-noise codes that are candidates for selection are supplied to the corresponding multiplier; and the measuring apparatus can be synchronized with the first pseudo-noise codes.

7. The gate array programming device according to claim 6, wherein each of the selectors periodically and repeatedly selects the second pseudo-noise codes under a fixed order and timing, and each of the adders performs cumulative addition using a first delay unit having a time delay that is the same as the selection period of the second pseudo-noise codes in the corresponding selector.

8. The gate array programming device according to claim 6, wherein said pseudo-noise code generator generates in parallel all of the second pseudo-noise codes through multiple second delay units based on a single third pseudo-noise code having the same code sequences as the first pseudo-noise codes.

9. The gate array program device according to claim 8, wherein said third pseudo-noise code is a pseudo-noise code pre-stored in the memory region inside said gate array.

10. The gate array program device according to claim 6, wherein said M number can be different values for each programming of the gate array and wherein said N number can be different values for each programming of the gate array.

11. A measuring apparatus having a reconfigurable gate array, wherein said gate array comprises:
a pseudo-noise code generator for generating K number of second pseudo-noise codes, each of different phases, which are the same code sequences as a first pseudo-noise code contained in signals under test;
a selector, wherein the candidates for selection are two or more M number of second pseudo-noise codes from among said K number of second pseudo-noise codes, there are two or more N number of selectors for selecting and outputting one of the second pseudo-noise codes from candidates for selection, and the second pseudo-noise codes that are candidates for selection of a certain selector are outside candidates for selection of the other selectors;
a multiplier, wherein there are N number of multipliers, each of which is connected to a respective selector, and the second pseudo-noise codes output by the corresponding selector are multiplied by the first pseudo-noise codes;
an adder, wherein there are N number of adders, each of which is connected to a respective multiplier, and the multiplication results output by the corresponding multiplier are cumulatively added for each phase of the second pseudo-noise codes corresponding to the multiplication results; and
a detector for detecting, as the phase of the first pseudo-noise codes, the phase of the second pseudo-noise codes corresponding to addition results for which the absolute value is at a maximum, or addition results exceeding a predetermined threshold value, from among the addition results of the adder;
wherein each selector selects the second pseudo-noise codes as the same chip data of the first pseudo-noise codes are being supplied to the corresponding multiplier so that all of the second pseudo-noise codes that are candidates for selection are supplied to the corresponding multiplier; and the measuring apparatus can be synchronized with the first pseudo-noise codes.

12. The measuring apparatus according to claim 11, wherein each of the selectors periodically and repeatedly selects the second pseudo-noise codes under a fixed order and timing, and each of the adders performs cumulative addition using a first delay unit having a time delay that is the same as the selection period of the second pseudo-noise code in the corresponding selector.

13. The measuring apparatus according to claim 11, wherein said pseudo-noise code generator generates in parallel all of the second pseudo-noise codes through multiple second delay units based on a single third pseudo-noise code having the same code sequences as the first pseudo-noise codes.

14. The measuring apparatus according to claim 13, wherein said third pseudo-noise code is a pseudo-noise code pre-stored in the memory region inside said gate array.

15. The measuring apparatus according to claim 11, wherein said M number can be different values for each programming of the gate array and wherein said N number can be different values for each programming of the gate array.

16. A measuring apparatus having a memory for storing signals under test and a reconfigurable gate array that operates by a clock that is faster than the chip rate of the signals under test, wherein said gate array comprises:
a pseudo-noise code generator for generating K number of second pseudo-noise codes, each of different phases, which are the same code sequences as a first pseudo-noise code included in signals under test;
a selector, wherein the candidates for selection are two or more M number of second pseudo-noise codes from among said K number of second pseudo-noise codes, there are two or more N number of selectors for selecting and outputting one of the second pseudo-noise codes from candidates for selection, and the second pseudo-noise codes that are candidates for selection of a certain selector are outside the candidates for selection of the other selectors;
a multiplier, wherein there are N number of multipliers, each of which is connected to a respective selector, and the second pseudo-noise code output by the corresponding selector is multiplied by the first pseudo-noise code contained in the signals under test read from said memory;
an adder, wherein there are N number of adders, each of which is connected to a respective multiplier, and the multiplication results output by the corresponding multiplier are cumulatively added for each phase of the second pseudo-noise codes corresponding to the multiplication results; and
a detector for detecting, as the phase of the first pseudo-noise codes, the phase of the second pseudo-noise codes corresponding to addition results for which the absolute value is at a maximum, or addition results exceeding a predetermined threshold value, from among the addition results of the adder;
wherein each selector selects the second pseudo-noise codes as the same chip data of the first pseudo-noise codes are being supplied to the corresponding multiplier so that all of the second pseudo-noise codes that are candidates for selection are supplied to the corresponding multiplier; and the measuring apparatus can be synchronized with the first pseudo-noise codes.

17. The measuring apparatus according to claim 16, wherein each of the selectors periodically and repeatedly selects the second pseudo-noise codes under a fixed order and timing, and each of the adders performs cumulative addition using a first delay unit having a time delay that is the same as the selection period of the second pseudo-noise code in the corresponding selector.

18. The measuring apparatus according to claim 16, wherein said pseudo-noise code generator generates in parallel all of the second pseudo-noise codes through multiple second delay units based on a single third pseudo-noise code having the same code sequences as the first pseudo-noise codes.

19. The measuring apparatus according to claim 18, wherein said third pseudo-noise code is a pseudo-noise code pre-stored in the memory region inside said gate array.

20. The measuring apparatus according to claim 16, wherein said M number can be different values for each programming of the gate array and wherein said N number can be different values for each programming of the gate array.

21. A computer readable storage media containing executable computer program instructions which when executed make a computer to program a reconfigurable gate array such that a measuring apparatus is synchronized with the first pseudo-noise codes contained in signals under test, wherein said computer being a part of or being connected to said measuring apparatus having said gate array, wherein the programmed gate array comprises:
a pseudo-noise code generator generating K number of second pseudo-noise codes, each of different phases, which are the same code sequences as a first pseudo-noise code included in signals under test;
a selector, wherein the candidates for selection are two or more M number of second pseudo-noise codes from among said K number of second pseudo-noise codes, there are two or more N number of selectors for selecting and outputting one of the second pseudo-noise codes from candidates for selection, and the second pseudo-noise codes that are candidates for selection of a certain selector are outside candidates for selection of the other selectors;
a multiplier, wherein there are N number of multipliers, each of which is connected to a respective selector, and the second pseudo-noise code output by the corresponding selector is multiplied by the first pseudo-noise codes;
an adder, wherein there are N number of adders, each of which is connected to a respective multiplier, and the multiplication results output by the corresponding multiplier are cumulatively added for each phase of the second pseudo-noise codes corresponding to the multiplication results; and
a detector for detecting, as the phase of the first pseudo-noise codes, the phase of the second pseudo-noise codes corresponding to addition results for which the absolute value is at a maximum, or addition results exceeding a predetermined threshold value, from among the addition results of the adder; and
wherein each selector selects the second pseudo-noise code as the same chip data of the first pseudo-noise codes are being supplied to the corresponding multiplier so that all of the second pseudo-noise codes that are candidates for selection are supplied to the corresponding multiplier.

22. The storage medium according to claim 21, wherein each of the selectors periodically and repeatedly selects the second pseudo-noise codes under a fixed order and timing, and each of the adders performs cumulative addition using a first delay unit having a time delay that is the same as the selection period of the second pseudo-noise code in the corresponding selector.

23. The storage medium according to claim 21, wherein said pseudo-noise code generator generates in parallel all of the second pseudo-noise codes through multiple second delay units based on a single third pseudo-noise code having the same code sequences as the first pseudo-noise codes.

24. The storage medium according to claim 23, wherein said third pseudo-noise code is a pseudo-noise code pre-stored in the memory region inside said gate array.

25. The storage medium according to claim 21, wherein said M number can be different values for each programming of the gate array and wherein said N number can be different values for each programming of the gate array.

26. A computer readable storage media containing executable computer program instructions which when executed make a computer to program a reconfigurable gate array such that a measuring apparatus is synchronized with the first pseudo-noise codes contained in signals under test, wherein said computer being a part of or being connected to said measuring apparatus having said gate array, wherein said gate array operating by a clock that is faster than the chip rate of the signals under test, wherein the programmed gate array comprises:
a pseudo-noise code generator generating K number of second pseudo-noise codes, each of different phases, which are the same code sequences as a first pseudo-noise code included in signals under test;
a selector, wherein the candidates for selection are two or more M number of second pseudo-noise codes from among said K number of second pseudo-noise codes, there are two or more N number of selectors for selecting and outputting one of the second pseudo-noise codes from candidates for selection, and the second pseudo-noise codes that are candidates for selection of a certain selector are outside candidates for selection of the other selectors;
a multiplier, wherein there are N number of multipliers, each of which is connected to a respective selector, and the second pseudo-noise code output by the corresponding selector is multiplied by the first pseudo-noise code contained in the signals under test read from said memory;
an adder, wherein there are N number of adders, each of which is connected to a respective multiplier, and the multiplication results output by the corresponding multiplier are cumulatively added for each phase of the second pseudo-noise codes corresponding to the multiplication results; and
a detector for detecting, as the phase of the first pseudo-noise codes, the phase of the second pseudo-noise codes corresponding to addition results for which the absolute value is at a maximum, or addition results exceeding a predetermined threshold value, from among the addition results of the adder; and
wherein each selector selects the second pseudo-noise code as the same chip data of the first pseudo-noise codes are being supplied to the corresponding multiplier so that all of the second pseudo-noise codes that are candidates for selection are supplied to the corresponding multiplier.

27. The storage medium according to claim 26, wherein each of the selectors periodically and repeatedly selects the second pseudo-noise codes under a fixed order and timing, and each of the adders performs cumulative addition using a first delay unit having a time delay that is the same as the selection period of the second pseudo-noise code in the corresponding selector.

28. The storage medium according to claim 26, wherein said pseudo-noise code generator generates in parallel all of the second pseudo-noise codes through multiple second delay units based on a single third pseudo-noise code having the same code sequences as the first pseudo-noise codes.

29. The storage medium according to claim 28, wherein said third pseudo-noise code is a pseudo-noise code pre-stored in the memory region inside said gate array.

30. The storage medium according to claim 26, wherein said M number can be different values for each programming of the gate array and wherein said N number can be different values for each programming of the gate array.
